(19) United States
(12) Patent Application Publication
(10) Pub. No.: US 2012/0059568 A1
(43) Pub. Date: Mar. 8, 2012

(54) ENGINE FUEL INJECTION CONTROL APPARATUS

(75) Inventor: Hiroyuki MATSUMOTO, Kobe-shi (JP)

(73) Assignee: MITSUBISHI ELECTRIC CORPORATION, Tokyo (JP)

(21) Appl. No.: 13/051,487

(22) Filed: Mar. 18, 2011

(30) Foreign Application Priority Data
Sep. 8, 2010 (JP) 2010-200925

(51) Int. Cl. F02D 41/04

(52) U.S. Cl. 701/104

(57) ABSTRACT

In the case where it is determined, based on a throttle opening degree change detected by a throttle sensor 16, that the engine is in the acceleration mode, an engine fuel injection control apparatus according to the present invention calculates a correction coefficient Krt in accordance with a crankshaft rotation count RCNT during a time between the immediately asynchronous injection and the present asynchronous injection, and then corrects the amount of a fuel injected through the present asynchronous injection, based on the correction coefficient Krt.

### BACKGROUND OF THE INVENTION

1. Field of the Invention

The present invention relates to an engine fuel injection control apparatus.

2. Description of the Related Art

To date, it has been known that in a 4-stroke engine for a vehicle where electronic fuel injection is performed, the fuel injection amount is corrected so as to increase (hereinafter, referred to as “amount increasing correction”) when the vehicle is accelerated; as the method for amount increasing correction, there is known a method where in addition to the synchronous injection in which fuel is injected at a predetermined crank angle, asynchronous injection is performed when it is determined from a throttle opening degree difference (changing amount) that the vehicle is in the acceleration mode.

There is also known a fuel injection control apparatus in which, in the case where the acceleration mode is continued for a predetermined time in a universal engine, determination of the acceleration mode is stopped so that unnecessary amount increasing correction is prevented from being performed (for example, refer to Patent Document 1).
Patent Document 1: Japanese Patent Application Laid-Open No. 2009-108774

Meanwhile, as a throttle operation method, there exists a so-called snap operation method where immediately after rapidly opened, a throttle is rapidly closed. In the case where the snap operation is implemented in a high-response engine such as a four-cylinder engine, the rotation speed of the engine rises in response to the throttle operation; however, in some of slow-response engines such as a single-cylinder engine and the like, the rotation speed of the engine does not rise in response to the throttle operation.

In the case of the foregoing single-cylinder engine, when the snap operation is implemented, especially in a rapid manner, there is likely to occur a case where the rotation speed of the engine does not rise. The foregoing case occurs because even though it is determined based on the rapid opening of the throttle that the engine is in the acceleration mode and an asynchronous injection is implemented, a necessary amount of air is not supplied because the throttle is closed before the combustion starts and hence no combustion required for the engine rotation speed to rise is performed.

In this case, because even though the fuel is increased by the asynchronous injection, no combustion required for the engine rotation speed to rise can be performed, the extra fuel cannot be consumed sufficiently; as a result, an overrich fuel-air mixture is produced. There has been a problem that in the case where this kind of snap operation is continuously repeated, the level of being overrich becomes excessive, thereby causing an engine stall or an afterfire.

Moreover, there has been a problem that when, as in a technology disclosed in Japanese Patent Application Laid-Open No. 2009-108774 (Patent Document 1), the determination of acceleration mode is performed only from the number of acceleration-mode detection instances or a detection interval (time) and based on the determination, the amount increasing correction (asynchronous injection) is prohibited for a predetermined time or amount decreasing is performed, amount increasing becomes insufficient in the case where acceleration accompanied by the rise in the engine rotation speed should be performed during the predetermined time, whereby the acceleration performance is deteriorated.

### SUMMARY OF THE INVENTION

The present invention has been implemented in order to solve the foregoing problems in those conventional systems; the objective thereof is to obtain an engine fuel injection control apparatus that is capable of not only preventing an engine stall and an afterfire but also ensuring excellent drivability.

An engine fuel injection control apparatus according to the present invention includes an electronic control unit that performs synchronous injection control where a fuel in a quantity calculated in accordance with an operation condition of an engine is injected in synchronization with a signal generated every predetermined crank angle by a crank angle sensor provided on a crankshaft of the engine and that performs asynchronous injection control where when an acceleration mode is detected based on a change in the opening degree indicated by a throttle sensor for detecting the opening/closing state of a throttle valve provided in an intake system of the engine, a fuel in a quantity calculated in accordance with the acceleration mode is injected at a timing that is different from the timing for the synchronous injection; the engine fuel injection control apparatus is characterized in that the electronic control unit has an asynchronous injection amount correction unit that corrects the amount of a fuel injected through the present asynchronous injection, based on a crankshaft rotation count obtained through the crank angle sensor during a time between the immediately previous asynchronous injection and the present asynchronous injection.

In the present invention, the engine fuel injection control apparatus is preferably configured in such a manner that the asynchronous injection amount correction unit corrects the amount of a fuel injected through the asynchronous injection, based on a correction coefficient that becomes larger as the crankshaft rotation count increases.

Moreover, in the present invention, the engine fuel injection control apparatus is preferably configured in such a manner that there is provided a water temperature sensor for detecting the temperature of a coolant for the engine, and the asynchronous injection amount correction unit corrects the amount of a fuel injected through the asynchronous injection, based on a correction coefficient that becomes larger as the crankshaft rotation count and the detected water temperature increase.

Moreover, an engine fuel injection control apparatus according to the present invention includes an electronic control unit that performs synchronous injection control where a fuel in a quantity calculated in accordance with an operation condition of an engine is injected in synchronization with a signal generated every predetermined crank angle by a crank angle sensor provided on a crankshaft of the engine and that performs asynchronous injection control where when an acceleration mode is detected based on a change in the opening degree indicated by a throttle sensor for detecting the opening/closing state of a throttle valve provided in an intake system of the engine, a fuel in a quantity calculated in accordance with the acceleration mode is injected at a timing that is different from the timing for the synchronous injection; the engine fuel injection control apparatus is characterized in that the electronic control unit has an asynchronous injection amount correction unit that corrects the amount of a fuel injected through the present asynchronous injection, based on an ignition count during a time between the immediately previous asynchronous injection and the present asynchronous injection.

Furthermore, an engine fuel injection control apparatus according to the present invention includes an electronic control unit that performs synchronous injection control where a fuel in a quantity calculated in accordance with an operation condition of an engine is injected in synchronization with a signal generated every predetermined crank angle by a crank angle sensor provided on a crankshaft of the engine and that performs asynchronous injection control where when an acceleration mode is detected based on a change in the opening degree indicated by a throttle sensor for detecting the opening/closing state of a throttle valve provided in an intake system of the engine, a fuel in a quantity calculated in accordance with the acceleration mode is injected at a timing that is different from the timing for the synchronous injection; the engine fuel injection control apparatus is characterized in that the electronic control unit has an asynchronous injection amount correction unit that corrects the amount of a fuel injected through the present asynchronous injection, based on a synchronous injection count during a time between the immediately previous asynchronous injection and the present asynchronous injection.

In an engine fuel injection control apparatus according to the present invention, the electronic control unit has an asynchronous injection amount correction unit that corrects the amount of a fuel injected through the present asynchronous injection, based on a crankshaft rotation count obtained through the crank angle sensor during a time between the immediately previous asynchronous injection and the present asynchronous injection; therefore, the present asynchronous injection amount can be corrected in accordance with the fuel consumption situation of the immediately previous asynchronous injection. As a result, not only an engine stall and an afterfire can be prevented, but also excellent acceleration performance can be achieved; thus, excellent drivability can be ensured.

Moreover, in an engine fuel injection control apparatus according to the present invention, the electronic control unit has an asynchronous injection amount correction unit that corrects the amount of a fuel injected through the present asynchronous injection, based on an ignition count during a time between the immediately previous asynchronous injection and the present asynchronous injection; therefore, the present asynchronous injection amount can be corrected in accordance with the fuel consumption situation of the immediately previous asynchronous injection. As a result, not only an engine stall and an afterfire can be prevented, but also excellent acceleration performance can be achieved; thus, excellent drivability can be ensured.

Still moreover, in an engine fuel injection control apparatus according to the present invention, the electronic control unit has an asynchronous injection amount correction unit that corrects the amount of a fuel injected through the present asynchronous injection, based on a synchronous injection count during a time between the immediately previous asynchronous injection and the present asynchronous injection; therefore, the present asynchronous injection amount can be corrected in accordance with the fuel consumption situation of the immediately previous asynchronous injection. As a result, not only an engine stall and an afterfire can be prevented, but also excellent acceleration performance can be achieved; thus, excellent drivability can be ensured.

The foregoing and other object, features, aspects, and advantages of the present invention will become more apparent from the following detailed description of the present invention when taken in conjunction with the accompanying drawings.

### BRIEF DESCRIPTION OF THE DRAWINGS

FIG. 1 is a diagram schematically illustrating the overall configuration of an engine control system to which an engine fuel injection control apparatus according to Embodiment 1 of the present invention is applied;

FIG. 2 is a timing chart representing asynchronous injection amount calculation processing in asynchronous injection control performed in an engine fuel injection control apparatus according to Embodiment 1 of the present invention;

FIG. 3 is a graph for explaining a method of calculating a correction coefficient Krt for an asynchronous injection amount in an engine fuel injection control apparatus according to Embodiment 1 of the present invention;

FIG. 4 is a flowchart representing a constant-time-routine control procedure in an engine fuel injection control apparatus according to Embodiment 1 of the present invention; and

FIG. 5 is a flowchart representing a crank-angle interruption-routine control procedure in an engine fuel injection control apparatus according to Embodiment 1 of the present invention.

### DETAILED DESCRIPTION OF THE PREFERRED EMBODIMENTS

### Embodiment 1

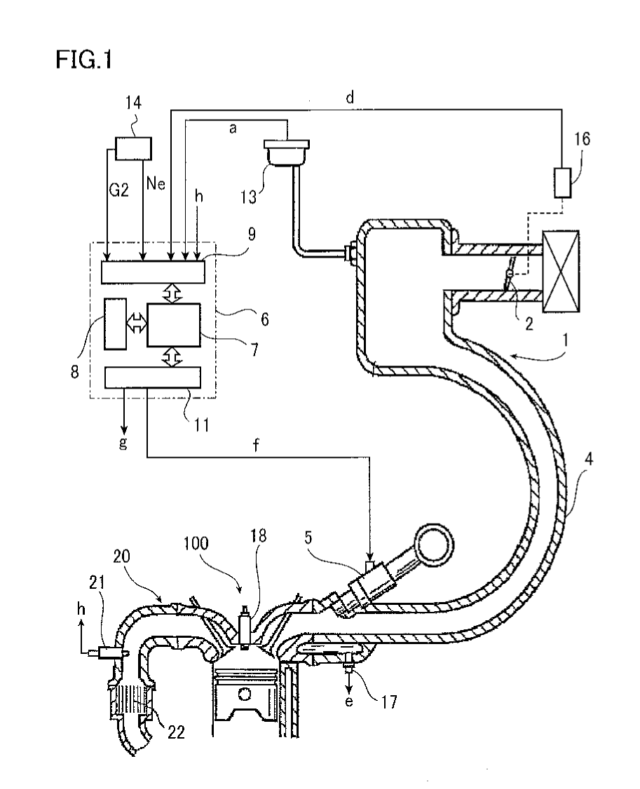

An engine fuel injection control apparatus according to Embodiment 1 of the present invention will be explained below with reference to the accompanying drawings. FIG. 1 is a diagram schematically illustrating the overall configuration of an engine control system to which an engine fuel injection control apparatus according to Embodiment 1 of the present invention is applied. In FIG. 1, an engine 100 is a single-cylinder four-stroke engine for a motorcycle, for example; in an intake system 1 of the engine 100, there is disposed a throttle valve 2 that opens and closes in response to depression of the throttle glip (unillustrated).

In the intake system 1, an intake pipe 4 is provided at the downstream side of the throttle valve 2; in the vicinity of the end portion, at the engine 100, of the intake pipe 4, there is provided a fuel injection valve (injector) 5 that is controlled by an electronic control unit 6. Inside the cylinder of the engine 100, there is provided a spark plug 18 that is controlled by the electronic control apparatus 6.

Furthermore, as sensors for detecting the operation condition of the engine 100, there are provided, for example, an intake pipe pressure sensor 13 for detecting the pressure in the intake pipe 4, a crank angle sensor 14 provided on a crankshaft (unillustrated) of the engine 100, a throttle sensor 16 for detecting the opening/closing state of the throttle valve 2, a water temperature sensor 17 for detecting the temperature of coolant for the engine 100, and an oxygen sensor 21 for measuring the concentration of oxygen in an exhaust gas in an exhaust system 20 of the engine 100.

An electronic control unit (ECU) 6 is configured mainly with a microcomputer system and is provided with a central processing unit (CPU) 7, a storage device (memory) 8, an input interface 9, and an output interface 11.

In the electronic control unit 6, to the input interface 9, there are inputted an intake pressure signal “a” outputted from the intake pipe pressure sensor 13, a crank angle signal G2 and a rotation speed signal Ne outputted from the crank angle sensor 14, a throttle opening degree signal “d” outputted from the throttle sensor 16, a water temperature signal “e” outputted from the water temperature sensor 17, and a voltage signal “h” outputted from the oxygen sensor 21. Meanwhile, from the output interface 11, there are outputted a fuel injection signal “f” for the fuel injection valve 5 and an ignition pulse “g” for the spark plug 18.

A program for controlling the fuel injection valve 5 is incorporated in the storage device 8 of the electronic control unit 6; the central processing unit 7 calculates an opening duration of the fuel injection valve 5, i.e., a final energization time T, based on the control program in the storage device 8.

By, as main driving-condition information, utilizing the intake pressure signal “a” and the rotation speed signal Ne, the central processing unit 7 determines various kinds of correction coefficients in accordance with the operation situation of the engine 100, and corrects a basic fuel injection time by use of the various kinds of correction coefficients so as to determine the final energization time T for the fuel injection valve 5. Accordingly, the central processing unit 7 controls the fuel injection valve 5 every predetermined crank angle during the final energization time T so as to make the fuel injection valve 5 inject into the intake system 1 a necessary fuel in accordance with the load condition of the engine 100.

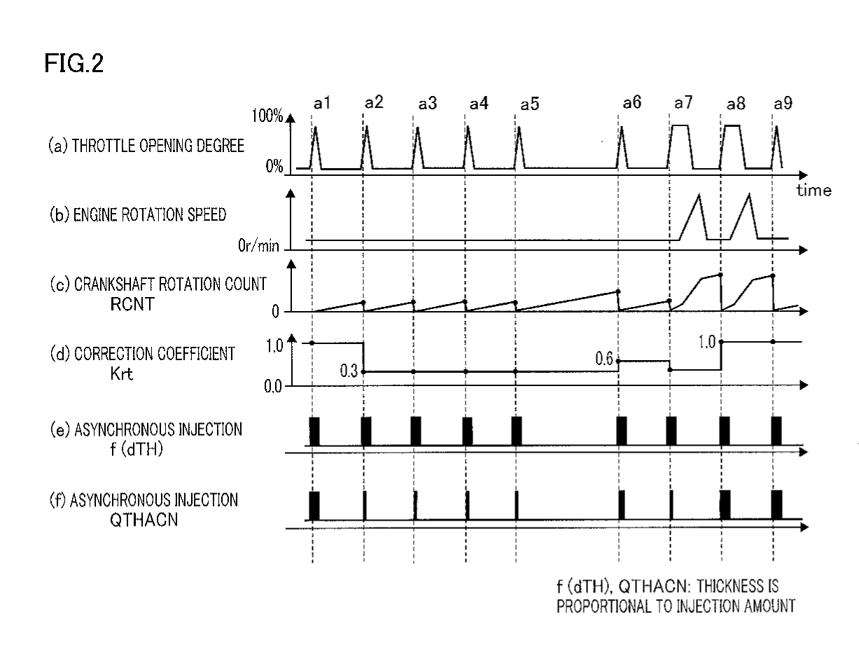

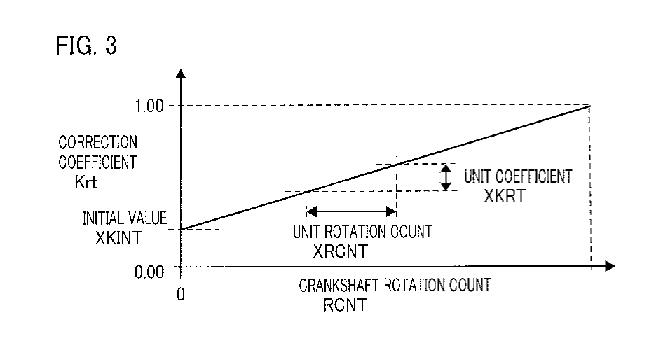

FIG. 2 is a timing chart representing asynchronous injection amount calculation processing in asynchronous injection control performed in an engine fuel injection control apparatus according to Embodiment 1 of the present invention; the waveform (a) represents the throttle opening degree; the waveform (b) represents the engine rotation speed; the waveform (c) represents the crankshaft rotation count RCNT; the waveform (d) represents the correction coefficient Krt; the waveform (e) represents the asynchronous injection amount f(dTH); the waveform (f) represents the asynchronous injection amount QTHACN. FIG. 3 is a graph for explaining a method of calculating the correction coefficient Krt for an asynchronous injection amount in an engine fuel injection control apparatus according to Embodiment 1 of the present invention.

As represented in the timing chart in FIG. 2, the central processing unit 7 detects the opening degree difference (increasing change) of the throttle valve 2; in the case where the opening degree difference is the same as or larger than a predetermined value, the central processing unit 7 determines that the engine is in the acceleration mode, calculates the fuel injection amount, corresponding to the acceleration degree, for the asynchronous injection control, and then implements the asynchronous injection control at a predetermined timing.

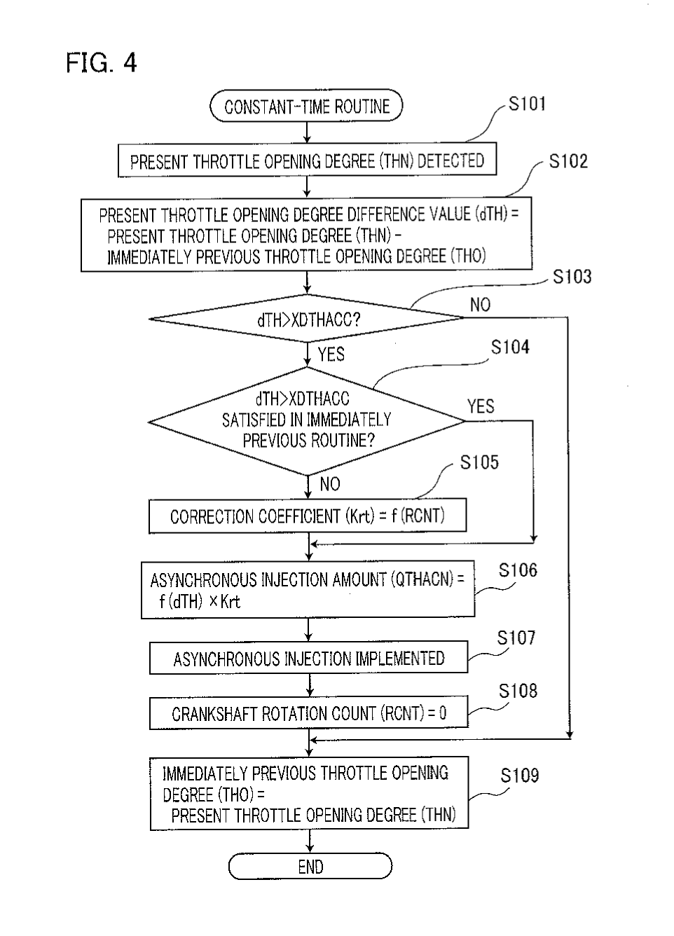

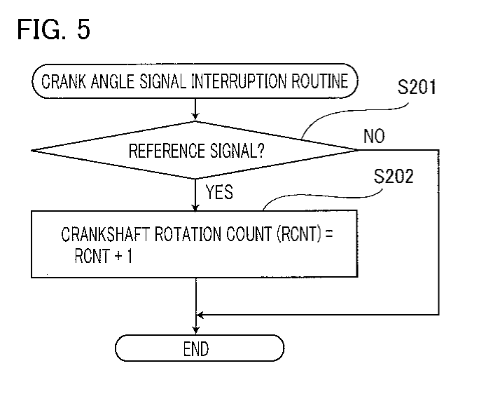

Next, there will be explained the operation of an engine fuel injection control apparatus according to Embodiment 1 of the present invention. FIG. 4 is a flowchart representing a constant-time-routine control procedure in an engine fuel injection control apparatus according to Embodiment 1 of the present invention; the constant-time-routine control procedure is called every constant time. FIG. 5 is a flowchart representing a crank-angle interruption-routine control procedure in an engine fuel injection control apparatus according to Embodiment 1 of the present invention; the foregoing routine is a crank angle signal interruption routine that is called when interruption is made by the crank angle signal G2. A well-known program can be utilized as the program for calculating the final energization time T for the fuel injection valve 5, while considering the various kinds correction coefficients; however, the drawing and explanation therefor will be omitted here.

In FIG. 4, at first, in the step S101, the present throttle opening degree THN is detected through the throttle opening degree signal “d” outputted from the throttle sensor 16; in the step S102, there is obtained a throttle opening degree difference value dTH (=THN−THO), which is the difference between the immediately previous throttle opening degree THO and the present throttle opening degree THN.

Subsequently, in the step S103, the throttle opening degree difference value dTH is compared with a throttle acceleration determination value XDTHACC, and it is determined whether or not the throttle opening degree difference dTH is larger than the throttle acceleration determination value XDTHACC. In the case where it is determined in the step S103 that dTH≦XDTHACC, i.e., in the case of “NO” determination, it is regarded that the present mode is not the acceleration mode; then the step S103 is followed by the step S109.

In the case where it is determined in the step S103 that [dTH>XDTHACC], i.e., in the case of “YES” determination, it is regarded that the present mode is the acceleration mode; then there is implemented processing for the acceleration mode, which is represented as the process from the step S104 to the step S108.

As the processing for the acceleration mode, at first, in the step S104, it is determined whether or not [dTH>XDTHACC] has been satisfied in the immediately previous routine. In the case where it is determined that [dTH>XDTHACC] has been satisfied in the immediately previous routine, i.e., in the case of “YES” determination, it is regarded that the acceleration mode has been being continued since the immediately previous routine; then the step S104 is followed not by the step S105 but by the step 106.

In contrast, in the case where it is determined in the step S104 that [dTH≦XDTHACC] has been satisfied in the immediate previous routine, i.e., in the case of “NO” determination, it is regarded that the mode has become the acceleration mode for the first time; then, the step S104 is followed by the step S105, where the correction coefficient Krt is calculated. In other words, in some cases, the constant-time routine is implemented twice or more times for a single rapid throttle opening operation; however, the correction coefficient Krt is calculated only once for a single rapid throttle opening operation.

In the step S105, the correction coefficient Krt corresponding to the crankshaft rotation count RCNT is calculated. The correction coefficient Krt is a function value f(RCNT) corresponding to the crankshaft rotation count RCNT, and is a coefficient whose value is basically proportional to the crankshaft rotation count RCNT. In Embodiment 1, as represented in FIG. 3, the function value f(RCNT) is a linear function in which the crankshaft rotation count RCNT is a variable, and a unit rotation count XRCNT, a unit coefficient XKRT, and an initial value XKINT are constants.

Subsequently, in the step S106, there is calculated the asynchronous injection amount QTHACN consisting of the function value f(dTH) corresponding to the throttle opening degree difference value dTH and the correction coefficient Krt.

The asynchronous injection amount f(dTH) is set to a value corresponding to the situation of acceleration, i.e., the throttle opening degree difference value dTH; mapping is preliminarily implemented in such a way that the asynchronous injection amount f(dTH) is proportional to the throttle opening degree difference value dTH. In Embodiment 1, it may be considered that asynchronous injection amount f(dTH) is the basic injection amount of the asynchronous injection amount QTHACN.

Subsequently, in the step S107, asynchronous injection is performed with the calculated asynchronous injection amount QTHACN; then, the step S107 is followed by the step S108, where the crankshaft rotation count RCNT is cleared to “0” for the next determination of “acceleration mode”.

Lastly, in the step S109, the present throttle opening degree THN is updated by the immediately previous throttle opening degree THO for the next call for the constant-time routine represented in FIG. 4; then, the routine represented in FIG. 4 is ended.

Next, there will be explained the interruption routine, through the crank angle signal G2, that is represented in FIG. 5. In FIG. 5, at first, in the step S201, it is determined whether or not the present crank angle signal is the reference signal; in the case where it is determined that the present crank angle signal is the reference signal, i.e., in the case of “YES” determination, the crankshaft rotation count RCNT is added by “1” in the step S202.

In contrast, in the case where it is determined in the step S201 that the present crank angle signal is not the reference signal, i.e., in the case of “NO” determination, the processing routine in FIG. 5 is immediately ended. The reference signal is a signal for detecting the reference position (e.g., the top dead center) of the crank and is one specific signal out of crank angle signals generated while the crank angle changes in the range of 360° C.

For example, as represented in FIG. 2, through the foregoing processing, the change (increasing change) in the opening degree of the throttle valve 2 is detected; in the case where the opening degree difference is the same as or larger than a predetermined value, it is determined that the present mode is the acceleration mode; the fuel injection amount, in the asynchronous injection control, that corresponds to the acceleration degree and the crankshaft rotation count; then, the asynchronous injection control is implemented.

The crankshaft rotation count serves as an index for the state of consumption of a fuel injected through asynchronous injection. For example, in the case where even after asynchronous injection is implemented, the engine rotation speed does not rise, i.e., the engine rotation speed remains low, it unit that combustion for the rise of the engine rotation speed is not made even though the asynchronous injection has been implemented in order to make the engine rotation speed rise; thus, the fuel has not sufficiently been consumed. At the same time, because the engine rotation speed is low, the crankshaft rotation count per given time decreases. That is to say, it can be considered that when the crankshaft rotation count is small, the fuel injected through the asynchronous injection is not sufficiently consumed.

For example, in contrast, in the case where after the asynchronous injection has been implemented, the engine rotation speed rises, the fuel injected through the asynchronous injection has been consumed in order to make the engine rotation speed rise. At the same time, because the engine rotation speed is high, the crankshaft rotation count per given time increases. That is to say, it can be considered that when the crankshaft rotation count is large, the fuel injected through the asynchronous injection has sufficiently been consumed.

Next, with reference to FIG. 2, the specific operation of Embodiment 1 will be explained in detail. In FIG. 2, each of the characters a1 through a9 in FIG. 2(a) denotes the timing when there is implemented throttle operation with which it is determined that the present mode is the acceleration mode. As represented in FIG. 2(b) showing the engine rotation speed, each of these throttle operations a1 through a6 and a9 is a quick snap operation unaccompanied by a rise in the engine rotation speed; each of the throttle operations a7 and a8 is a slow snap operation accompanied by a rise in the engine rotation speed.

With regard to the asynchronous injection amount f(dTH) shown in FIG. 2(e), there is represented a case where the same injection amount is calculated for the throttle operations a1 through a9; with regard to the asynchronous injection amount QTHACN shown in FIG. 2(f), there is represented a case where various injection amounts are calculated through the correction coefficients Krt.

The throttle operation a2 represented in FIG. 2 will be explained. With the throttle operation a2, the engine rotation speed (b) does not rise from the engine rotation speed at a time when asynchronous injection has been implemented through the immediately previous throttle operation (a1); the throttle operation (a2) is a snap operation that follows the immediately previous throttle operation (a1) at a relatively short interval. Because the engine rotation speed does not rise and the interval is short, the crankshaft rotation count RCNT represented in FIG. 2(c) becomes relatively small; therefore, the correction coefficient Krt represented in FIG. 2(d) becomes a small value (e.g., 0.3). As a result, as represented in FIG. 2(f), the asynchronous injection amount through the throttle operation (a2) is corrected to become considerably small compared with the asynchronous injection amount through the immediately previous throttle operation (a1) (for example, corrected to become 30% of the basic amount).

That is to say, in the case of continuous acceleration unaccompanied by a rise in the engine rotation speed, the asynchronous injection amount QTHACN through the immediately previous throttle operational is not sufficiently consumed; however, an overrich fuel-air mixture can be prevented by largely reducing the asynchronous injection amount QTHACN through the present throttle operation a2. The asynchronous injection amount QTHACN through each of the throttle operations a3, a4, and a5 is the same as the asynchronous injection amount through the throttle operation a2.

Next, the throttle operation a6 represented in FIG. 2 will be explained. With the throttle operation a6, although the engine rotation speed does not rise from the engine rotation speed at a time when asynchronous injection has been implemented through the immediately previous throttle operation (a5), the throttle operation a6 is a snap operation that follows the throttle operations a1 through a5 at a relatively long interval.

Therefore, as represented in FIG. 2(b), although the engine rotation speed does not rise, a long time elapses after the immediately previous throttle operation a5 has been implemented; thus, as represented in FIG. 2(c), the crankshaft rotation count RCNT becomes significantly large. Therefore, the correction coefficient Krt represented in FIG. 2(d) becomes an intermediate value (e.g., 0.6). As a result, the asynchronous injection amount QTHACN through the throttle operation a6 is corrected to become slightly small compared with the asynchronous injection amount f (dTH), which is a basic injection amount (for example, corrected to become approximately 60% of the basic amount).

That is to say, in the case where although the engine rotation speed does not rise, a considerably long time elapses after the immediately previous acceleration, the asynchronous injection amount QTHACN through the immediately previous throttle operation a5 is considerably consumed; therefore, not only an overrich fuel-air mixture can be prevented but also the acceleration performance can be enhanced, by appropriately reducing the asynchronous injection amount QTHACN through the present throttle operation a6.

Next, the throttle operation a8 represented in FIG. 2 will be explained. As is the case with each of the throttle operations a1 through a5, the throttle operation a8 is a snap operation that follows the immediately previous throttle operation a7 at a short interval after the asynchronous injection through the throttle operation a7; however, as represented in FIG. 2(b), the engine rotation speed rises after the asynchronous injection through the immediately previous throttle operation a7 is implemented. Because although for a short time, the engine rotation speed rises, the crankshaft rotation count RCNT represented in FIG. 2(c) becomes large; thus, the correction coefficient Krt represented in FIG. 2(d) becomes a large value (e.g., 1.0). As a result, the asynchronous injection amount QTHACN through the throttle operation a8 is hardly corrected to be reduced (e.g., 100% of the basic asynchronous injection amount f(dTH)).

That is to say, in the case of acceleration after the asynchronous injection accompanied by a rise in the engine rotation speed, the asynchronous injection amount QTHACN by the immediately previous throttle operation a7 has sufficiently been consumed; therefore, the asynchronous injection amount QTHACN through the present throttle operation a8 is not reduced, so that the acceleration performance can be kept satisfactory. The same applies to the next throttle operation a9.

### Embodiment 2

In Embodiment 1, the correction coefficient Krt is calculated through a linear function; however, in Embodiment 2, the correction coefficient Krt is calculated based on a one-axis map (table) where the axis denotes the crankshaft rotation count. In that case, for example, the mapping is implemented in such a way that the correction coefficient Krt increases as the crankshaft rotation count becomes larger. The other configurations are the same as those in Embodiment 1.

### Embodiment 3

In Embodiment 1, the correction coefficient Krt is calculated through a linear function; however, in Embodiment 3, the correction coefficient Krt is calculated based on a two-axis map where the axes denote the crankshaft rotation count and the other factor. In that case, the other factor signifies, for example, water temperature information based on the water temperature signal “e”; for example, the mapping is implemented in such a way that the correction coefficient Krt increases as the crankshaft rotation count becomes larger and the water temperature becomes higher. The other configurations are the same as those in Embodiment 1.

### Embodiment 4

In Embodiment 1, the crankshaft rotation count RCNT is counted up every 360° crank angle, in response to the reference signal, which is a crank angle signal; however, in Embodiment 4, the crankshaft rotation count RCNT is counted up every crank angle signal. The crankshaft rotation count RCNT may be counted up every ignition or every synchronous injection, instead of the crank angle signal. As is the case with Embodiment 1, in each of these cases, the crankshaft rotation count RCNT is cleared to “0” when asynchronous injection is implemented; then the number of respective instances is counted until the next determination of acceleration mode is made.

It should be understood that the present invention is not limited to Embodiments 1 through 4 described above, and the configuration of respective constituent elements is not limited to the configuration example in FIG. 1; it goes without saying that various modifications and alterations of the present invention will be apparent to those skilled in the art without departing from the scope and spirit of this invention.

What is claimed is:

1. An engine fuel injection control apparatus including an electronic control unit that performs synchronous injection control where a fuel in a quantity calculated in accordance with an operation condition of an engine is injected in synchronization with a signal generated every predetermined crank angle by a crank angle sensor provided on a crankshaft of the engine and that performs asynchronous injection control where when an acceleration mode is detected based on a change in the opening degree indicated by a throttle sensor for detecting the opening/closing state of a throttle valve provided in an intake system of the engine, a fuel in a quantity calculated in accordance with the acceleration mode is injected at a timing that is different from the timing for the synchronous injection, wherein the electronic control unit has an asynchronous injection amount correction unit that corrects the amount of a fuel injected through the present asynchronous injection, based on a crankshaft rotation count obtained through the crank angle sensor during a time between the immediately previous asynchronous injection and the present asynchronous injection.

2. The engine fuel injection control apparatus according to claim 1, wherein the asynchronous injection amount correction unit corrects the amount of a fuel injected through the asynchronous injection, based on a correction coefficient that becomes larger as the crankshaft rotation count increases.

3. The engine fuel injection control apparatus according to claim 1, further including a water temperature sensor that detects the temperature of a coolant for the engine, wherein the asynchronous injection amount correction unit corrects the amount of a fuel injected through the asynchronous injection, based on a correction coefficient that becomes larger as the crankshaft rotation count and the detected water temperature increase.

4. An engine fuel injection control apparatus including an electronic control unit that performs synchronous injection control where a fuel in a quantity calculated in accordance with an operation condition of an engine is injected in synchronization with a signal generated every predetermined crank angle by a crank angle sensor provided on a crankshaft of the engine and that performs asynchronous injection control where when an acceleration mode is detected based on a change in the opening degree indicated by a throttle sensor for detecting the opening/closing state of a throttle valve provided in an intake system of the engine, a fuel in a quantity calculated in accordance with the acceleration mode is injected at a timing that is different from the timing for the synchronous injection, wherein the electronic control unit has an asynchronous injection amount correction unit that corrects the amount of a fuel injected through the present asynchronous injection, based on an ignition count during a time between the immediately previous asynchronous injection and the present asynchronous injection.

5. An engine fuel injection control apparatus including an electronic control unit that performs synchronous injection control where a fuel in a quantity calculated in accordance with an operation condition of an engine is injected in synchronization with a signal generated every predetermined crank angle by a crank angle sensor provided on a crankshaft of the engine and that performs asynchronous injection control where when an acceleration mode is detected based on a change in the opening degree indicated by a throttle sensor for detecting the opening/closing state of a throttle valve provided in an intake system of the engine, a fuel in a quantity calculated in accordance with the acceleration mode is injected at a timing that is different from the timing for the synchronous injection, wherein the electronic control unit has an asynchronous injection amount correction unit that corrects the amount of a fuel injected through the present asynchronous injection, based on a synchronous injection count during a time between the immediately previous asynchronous injection and the present asynchronous injection.
